(19) United States
(12) Patent Application Publication
(10) Pub. No.: US 2024/0410789 A1
(43) Pub. Date: Dec. 12, 2024

(54) Test Bench for Safeguarding Driver Assistance Functions of an Automated Motor Vehicle, Method for Controlling Such a Test Bench, and a Control Device for Such a Test Bench

(71) Applicant: Bayerische Motoren Werke AKtiengesellschaft, Muenchen (DE)

(72) Inventor: Martin HELLER, Graben (DE)

(21) Appl. No.: 18/688,838

(22) PCT Filed: Sep. 20, 2022
(86) PCT No.: PCT/EP2022/076070

§ 371 Date: Mar. 4, 2024

(30) Foreign Application Priority Data
Oct. 12, 2021 (DE) 10 2021 126 342.5

(51) Int. Cl. G01M 17/007

(52) U.S. Cl. CPC G01M 17/007

(57) ABSTRACT

Systems, methods, and apparatuses are provided for safeguarding driver assistance functions of an automated motor vehicle. A test bench includes a support platform for a target, a magnetic track surface for the support platform, and a control device connected to the magnetic track surface. The control device is configured to output a magnetic track surface control signal to the magnetic track surface. Using the magnetic track surface control signal, the control device is also configured to adjust a position of the support platform relative to the magnetic track surface, and/or a distance between the support platform and the magnetic track surface by changing magnetic forces generated by the magnetic track surface.

### BACKGROUND AND SUMMARY

The present subject matter relates to a test bench for safeguarding driver assistance functions of an automated motor vehicle, a method for controlling such a test bench, and a control device for such a test bench.

Test benches may be employed for safeguarding driver assistance functions of an automated test vehicle, for example in the context of homologation.

Such test benches usually comprise at least one so-called target which interacts with the automated test vehicle in a predetermined manner in the context of a test or check. It is conceivable that the at least one target is to be recognized by the automated test vehicle in the context of the test and/or that the automated motor vehicle has to avoid the target in the context of the test.

In order to be able to change a position of the at least one target on the test bench before, during and/or after or between tests, the target may be moved over a test bench surface in a manner driven externally, e.g. using cable pulls, and/or in a manner driven internally, e.g. using an electric motor and an energy store connected to the electric motor.

During operation of such a conventional test bench involving pedestrians and/or vehicles being simulated via the target(s), for example, problems may occur in the context of energy supply and drive of the targets. In the course of the tests, for example, delays may occur on account of discharged energy stores of the targets.

Moreover, the weather causes changes in coefficients of friction of the test bench surface, such that this may adversely influence a repeatability of test results.

In addition, a conventional test bench set-up is usually large in terms of structural engineering and entails a certain risk of damage to the test vehicle but also to the test bench and the target itself when the test vehicle drives over the test bench surface.

Against the background of this prior art, the object of the present subject matter consists in specifying a device and a method which are suitable for overcoming at least the abovementioned disadvantages of the prior art.

Accordingly, the object is achieved using a test bench for safeguarding driver assistance functions of an automated motor vehicle.

The test bench is distinguished by the fact that the test bench comprises at least one support platform for a target and a magnetic track surface for the at least one support platform.

The test bench is furthermore distinguished by the fact that a control device connected to the magnetic track surface is provided.

The control device is configured to output a magnetic track surface control signal to the magnetic track surface and, using the magnetic track surface control signal, to adjust a position of the support platform relative to the magnetic track surface.

The control device is additionally or alternatively configured to adjust a distance between the support platform and the magnetic track surface by changing magnetic forces generated by the magnetic track surface.

In other words, a test bench is provided which allows driver assistance functions of an automated motor vehicle to be tested. The automated motor vehicle may therefore also be referred to as a subject or a test vehicle.

The test bench may also be referred to as a system for safeguarding driver assistance functions on the basis of magnetic-levitation-transportation-based freely movable and positionable (target) support platforms.

The test bench therefore preferably has dimensions such that the automated motor vehicle can traverse the test bench, in particular the magnetic track surface forming a test bench surface, and the at least one target can be situated on the test bench surface at the same time. During a test or experiment carried out on the test bench, the at least one target, which may also be referred to as a dummy, can be arranged together with the test vehicle on the magnetic track surface.

During the test, depending on the degree of automation, the motor vehicle can pass the target laterally and/or avoid the target, for example.

The test vehicle or motor vehicle can be an, in particular automated, automobile. The automated motor vehicle, in particular on account of driver assistance functions to be tested, can be configured to undertake lateral and/or longitudinal control at least in part and/or at times during automated driving of the motor vehicle.

Automated driving can be provided such that the locomotion of the motor vehicle takes place (substantially) autonomously.

The motor vehicle can be a motor vehicle of autonomy level 1, i.e. can comprise specific driver assistance systems which assist the driver when operating the vehicle, such as, for example, an adaptive cruise control (ACC).

The motor vehicle can be a motor vehicle of autonomy level 2, i.e. can be partly automated such that functions such as automatic parking, lane keeping or lateral control, general longitudinal control, acceleration and/or braking are undertaken by driver assistance systems.

The motor vehicle can be a motor vehicle of autonomy level 3, i.e. conditionally automated such that the driver does not constantly need to monitor the vehicle system. The motor vehicle independently carries out functions such as operating the turn signals, changing lanes and/or lane keeping. The driver can attend to other things but if necessary is prompted by the system to take control within an advance warning time.

The motor vehicle can be a motor vehicle of autonomy level 4, i.e. highly automated such that the control of the vehicle is permanently undertaken by the vehicle system. If the driving tasks are no longer managed by the system, the driver may be prompted to take control.

The motor vehicle can be a motor vehicle of autonomy level 5, i.e. fully automated such that the driver is not needed to perform the driving task. Apart from stipulating the destination and starting the system, no human intervention is needed. The motor vehicle can manage without a steering wheel and pedals.

In order to change a location of the target, i.e. to adjust the position of the support platform relative to the magnetic track surface and/or the distance between the support platform and the magnetic track surface, the magnetic track surface is activated using a control signal, the so-called magnetic track surface control signal.

The magnetic track surface is a part of the test bench on which the support platform for the at least one target is situated. The magnetic track surface may also be referred to as magnetic support platform surface.

In this case, the magnetic track surface is configured to utilize magnetic fields to bring the support platform and thus the target that is arrangeable on the support platform into a levitated state. For this purpose, the magnetic track surface can comprise coils arranged beneath the test bench surface.

The magnetic track surface can be an electromagnetic suspension (EMS) system or an electrodynamic suspension (EDS) system.

The electromagnetic suspension system comprises an electromagnet, which after being excited with DC current magnetizes a ferromagnetic material of the support platform arranged on an opposite side of an air gap, which brings about an attractive force between magnetic track surface and support platform. Since the attractive method may be unstable without regulation, active air gap regulation in the form of the magnetic track surface control signal can be used here.

The electrodynamic suspension system generates alternating magnetic fields that cause eddy currents in nonmagnetic electrical conductors, e.g. in aluminum, that are arranged on or in the support platform, the eddy currents preventing deeper penetration of the magnetic field, with the result of a repulsive force between the support platform and the magnetic track surface. In the repulsive method, too, it is conceivable to use active air gap regulation or distance regulation in the form of the magnetic track surface control signal.

A non-contact drive principle used can be that of the linear motor. In this case, currents are induced on one side of the air gap between magnetic track surface and support platform. The other, active side may be referred to as a stator by analogy with rotary machines. The stator can be installed as a long stator in and/or on the magnetic track surface or as a short stator in or on the support platform. Both systems can operate with superconducting coils and can be made more energy-efficient through the use of permanent magnets.

By virtue of the test bench described above, in particular by virtue of the use of the magnetic-track-based target base surface or the magnetic track surface, no drive and no energy supply are required in the target itself and frictionless, magnetic-field-controlled acceleration and corresponding movement of the target are possible. The support platform can be configured to be relatively flat, such that in the case of a collision with the target, there is no risk for the test vehicle driving over it. In summary, the test bench becomes safer, the targets themselves become more cost-effective, and the infrastructure is more sustainable.

What has been described above is set out and elaborated on in further detail below.

Adjusting the distance between the support platform and the magnetic track surface can comprise raising the support platform in order to levitate the latter from the magnetic track surface, and/or can comprise lowering the support platform in order to lower the latter from the levitated state onto the magnetic track surface.

Adjusting the position of the levitated support platform can comprise translationally and/or rotationally moving the support platform.

The test bench can comprise an air nozzle arrangement, in particular having a plurality of air nozzles, arranged and configured to generate an air cushion between the levitated support platform and the magnetic track surface.

The control device can be connected to the air nozzle arrangement and can be configured to output an air nozzle arrangement control signal to the air nozzle arrangement and to control the air cushion using the air nozzle arrangement control signal.

The test bench can comprise a position sensor arrangement connected to the control device and arranged and configured to detect a current position of the support platform as actual position and to output it to the control device.

The control device can be configured to generate the magnetic track surface control signal on the basis of a comparison of the actual position received from the position sensor arrangement and, in particular, the target position received from an external control device.

The control device can also be configured to generate the air nozzle arrangement control signal on the basis of a comparison of the actual position received from the position sensor arrangement and the target position received from the external control device.

Using different words and with reference to a concrete configuration, which is merely described by way of example and should not be regarded as restrictive for the present subject matter, what has been described above can be summarized as follows.

A flat, driveless, support platform can be provided, which can be brought to a levitated position by coils incorporated in the base surface and by electrically generated magnetic fields, such that this support platform is steerable and can be accelerated or braked via a magnetic track surface.

The magnetic track surface is a defined base surface that can be equipped with coils, in particular over the whole area. This surface corresponds to the required test field in which, for example, a rear end collision or target braking is simulated or expected. In this case, the energy supply required for the coils, and also a device for actuating the coils can be structurally integrated or incorporated in the roadway surface or beneath that. The visible surface of the magnetic track surface and/or of the support platform, i.e. the surface that comes into contact with the test vehicle, can be adapted to predefined or desired coefficients of friction using a coating.

Using targeted actuation of the coils and detection of the support platforms, the baseplates or support platforms can be freely controlled or moved and steered on the magnetic track surface.

Consequently, it is also possible for a plurality of targets to be simultaneously moved or deliberately stopped. Using the detection of the support platforms in a coordinate system of the magnetic track surface, exact positioning of the targets is also traceable and a complex GPS positioning measurement technique becomes obsolete or is merely necessary in an optional way.

Consequently, it is also possible to ensure that in the event of driving over in respect of a target, a risk owing to an elevated structure no longer arises. The system would be tied to the location and it would also ensure that homologation is possible only at the specific location of use.

The energy supply of the coils can be provided in the base substructure and the conventionally occurring problem of discharged batteries in the target can thus be avoided. On account of the drive by way of magnetic forces, wetness and moisture also have no or only little effect on the driving behavior of the targets.

As described above, the system can optionally also be provided with air nozzles that provide damping using an air cushion that arises below the support platforms. In the event of a failure of the coils or the magnetic field, controlled steering, movement and/or lowering of the support platform would likewise be possible here using pneumatics.

In addition, a method for controlling a test bench for safeguarding driver assistance functions of an automated motor vehicle is provided.

The test bench comprises at least one support platform for a target, a magnetic track surface for the at least one support platform, and a control device connected to the magnetic track surface.

The method is distinguished by the fact that it comprises outputting a magnetic track surface control signal to the magnetic track surface.

The method is furthermore distinguished by the fact that it comprises adjusting a position of the support platform relative to the magnetic track surface and/or a distance between the support platform and the magnetic track surface by changing magnetic forces generated by the magnetic track surface, using the magnetic track surface control signal.

The method can be a computer-implemented method, in particular. One, a plurality, or all of the steps of the method can be performed by a computer.

Adjusting the distance between the support platform and the magnetic track surface can comprise raising the support platform in order to levitate the latter from the magnetic track surface, and/or can comprise lowering the support platform in order to lower the latter from the levitated state onto the magnetic track surface.

Adjusting the position of the levitated support platform can comprise translationally and/or rotationally moving the support platform.

The test bench can comprise an air nozzle arrangement, in particular having a plurality of air nozzles, arranged and configured to generate an air cushion between the levitated support platform and the magnetic track surface.

The control device can be connected to the air nozzle arrangement. The method can comprise outputting an air nozzle arrangement control signal to the air nozzle arrangement using the control device and controlling the air cushion by means of or depending on the air nozzle arrangement control signal.

The test bench can comprise a position sensor arrangement connected to the control device. The method can comprise detecting a current position of the support platform as actual position and outputting the detected actual position to the control device.

The method can comprise generating the magnetic track surface control signal via the control device on the basis of a comparison of the actual position received from the position sensor arrangement and the target position received from an external control device.

Additionally, or alternatively, the method can comprise generating the air nozzle arrangement control signal via the control device on the basis of a comparison of the actual position received from the position sensor arrangement and the target position received from the external control device.

What has been described above with regard to the test bench analogously applies to the method, too, and vice versa.

In addition, a control device for a test bench for safeguarding driver assistance functions of an automated motor vehicle is provided, wherein the test bench comprises at least one support platform for a target, and a magnetic track surface for the at least one support platform.

The control device, which is connectable to the magnetic track surface, is distinguished by the fact that it is configured to output a magnetic track surface control signal to the magnetic track surface and, via the magnetic track surface control signal, to adjust a position of the support platform relative to the magnetic track surface and/or a distance between the support platform and the magnetic track surface by changing magnetic forces generated by the magnetic track surface.

The control device can be configured in particular to carry out the above-described method for controlling the test bench. The test bench can be the above-described test bench, in particular.

The control device can comprise or be a device for data processing. The control device can comprise or be configured as an electronic control unit (ECU) or an electronic control module (ECM).

It is also conceivable for the control device to comprise or be configured as and/or be connected to a backend, in particular a server.

The control device can comprise in particular a control device installed in or on the automated motor vehicle. It is conceivable for the test bench to be controlled, e.g. wirelessly, by a control device installed in or on the test vehicle.

What has been described above with regard to the test bench and the method analogously applies to the control device, too.

### BRIEF DESCRIPTION OF THE DRAWINGS

FIG. 1 schematically shows a test bench for safeguarding driver assistance functions of an automated motor vehicle in a perspective plan view,

FIG. 2 schematically shows the test bench from FIG. 1 in a side view, and

FIG. 3 schematically shows a flowchart of a method for controlling the test bench from FIGS. 1 and 2.

### DETAILED DESCRIPTION OF THE DRAWINGS

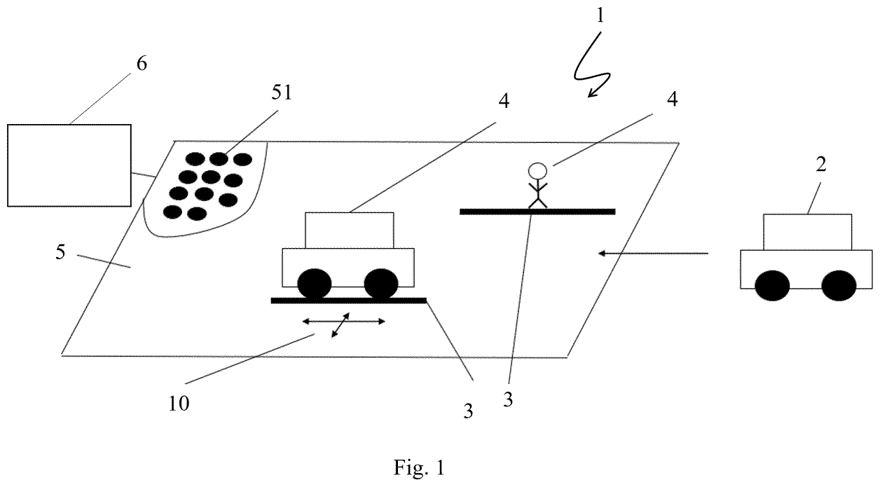

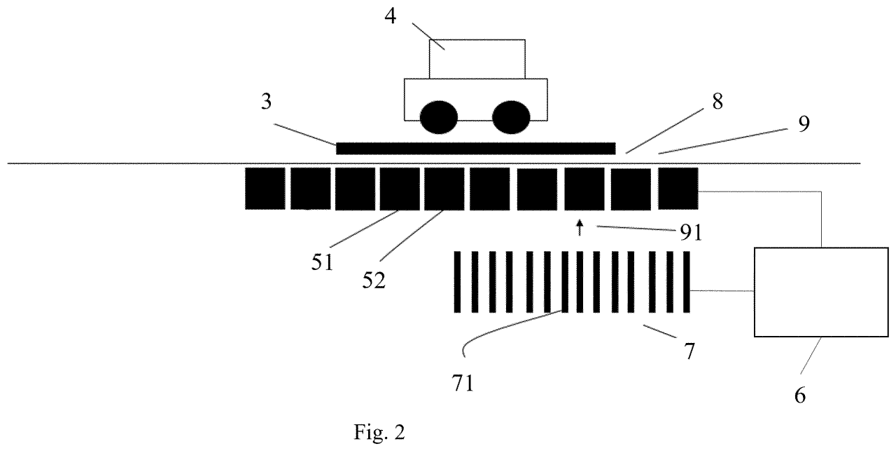

The test bench 1 illustrated in FIGS. 1 and 2 for safeguarding driver assistance functions of an automated motor vehicle 2, referred to below as test vehicle, comprises two support platforms 3, each for a target 4 arranged thereon, a magnetic track surface 5 for the two support platforms 3 and an air nozzle arrangement 7 having a plurality of air nozzles 71, which is arranged below a coil arrangement of the magnetic track surface 5, comprising a plurality of coils 51 and a position sensor arrangement 52.

The test bench 1 furthermore comprises a control device 6 connected to the magnetic track surface 5, in particular to the coils 51 and the position sensor arrangement 52, and to the air nozzle arrangement 7.

The position sensor arrangement 52 is configured to determine a respective current position of the two support platforms 3 and to output it as an actual position to the control device 6.

The control device 6 is configured to control a magnetic field 8 generated by the coils 51 via a magnetic track surface control signal output to the coils 51, and an air cushion 9 generated by the air nozzles 71 of the air nozzle arrangement 7 via an air nozzle arrangement control signal output to the air nozzle arrangement 7.

By changing the magnetic field 8 via the magnetic track surface control signal and the resultant magnetic forces on the two support platforms 3, it is possible to adjust a respective position of the two support platforms 3 relative to the magnetic track surface 5 and a respective distance between the two support platforms 3 and the magnetic track surface.

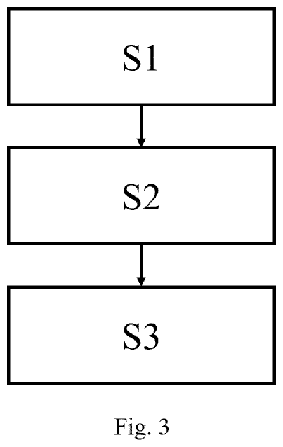

Adjusting the position of the support platforms 3 is also described in detail below with reference to FIG. 3, which illustrates the flowchart of the method for controlling the test bench 1 described above.

In a first step S1 of the method, the position sensor arrangement 52 determines a respective current position of the two support platforms 3 on the magnetic track surface 5 and outputs this position as an actual position to the control device 6.

In a second step S2 of the method, the control device 6 determines the magnetic track surface control signal and the air nozzle arrangement control signal on the basis of the respective current position of the two support platforms 3 and a respective target position of the two support platforms 3, and outputs the determined magnetic track surface control signal to the coil arrangement having the coils 52 and the determined air nozzle arrangement control signal to the air nozzle arrangement 7 having the air nozzles 71.

The target position can be obtained from an external control device (not illustrated), such as a personal computer of a test bench user, for example.

A third step S3 of the method involves adjusting or changing the actual position of the respective support platform 3 whose actual position does not correspond to the target position.

In the present case, this is the actual position of the support platform 3 that supports a further motor vehicle as the target 4, as is indicated by the arrows 10 signalling a movement in FIG. 1. By contrast, the actual position of the further support platform 3, which supports a human dummy as the target 4, corresponds to the target position, with the result that the actual position is not changed here.

For the purpose of changing the actual position of the support platform 3, the latter is firstly raised, i.e. spaced apart from the magnetic track surface 5, and thus brought into a levitated state above the magnetic track surface 5 as shown in FIG. 2, via the magnetic field 8 generated by the coils 51, more precisely via the magnetic forces that result from the magnetic field and act on the support platform 3. For this purpose, the magnetic field 8 is changed in accordance with the magnetic track surface control signal.

In addition, simultaneously with the raising of the support platform 3, the air nozzle arrangement 7 is activated via the air nozzle arrangement control signal in order to generate the air cushion 9 arranged between the support platform 3 and the magnetic track surface via an air stream 91 flowing through the coil arrangement.

This is followed by the support platform 3 being moved by translational and/or rotational movement of the support platform 3 via the magnetic field 8 that is generated by the coils 51 and varies in accordance with the magnetic track surface control signal.

The support platform 3 is moved until the actual position detected by the position sensor arrangement 52 and output to the control device 6 corresponds to the target position of the support platform 3.

In this case, the air cushion 9 is controlled in accordance with the actual position of the support platform 3, i.e. the air nozzles 71 of the air nozzle arrangement 7 are actuated via the air nozzle arrangement control signal such that the air cushion 9 moves with the support platform 3 relative to the magnetic track surface 5.

After the target position has been reached, the support platform 3 is lowered, which involves the support platform 3 being lowered from the levitated state onto the magnetic track surface 5 via the magnetic field 8 generated by the coils 51.

For this purpose, the magnetic field 8 is changed in accordance with the magnetic track surface control signal. The air nozzle arrangement 7 is deactivated via the air nozzle arrangement control signal in parallel with the lowering.

Using the air cushion 9, during the complete movement of the support platform, it is accordingly possible to ensure that in the event of a failure of the coil arrangement, the support platform does not drop onto the magnetic track surface 5, but rather can be lowered in a controlled manner via the air cushion 9.

Translational and/or rotational movement of the support platform 3 relative to the magnetic track surface 5 via the air cushion 9 would also be conceivable.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

### LIST OF REFERENCE SIGNS

1 Test bench
2 Test vehicle or automated motor vehicle
3 Support platform for target
4 Target
5 Coils
52 Position sensor arrangement
6 Control device
7 Air nozzle arrangement
71 Air nozzles
8 Magnetic field
9 Air cushion
91 Air stream
10 Movement directions of the support platform
S1-S3 Steps of the method for controlling the test bench

1.-10. (canceled)

11. A test bench for safeguarding driver assistance functions of an automated motor vehicle, comprising:
a support platform for a target;
a magnetic track surface for the support platform; and
a control device connected to the magnetic track surface and configured to:
output a magnetic track surface control signal to the magnetic track surface; and
using the magnetic track surface control signal, adjust:
a position of the support platform relative to the magnetic track surface, and/or
a distance between the support platform and the magnetic track surface, by changing magnetic forces generated by the magnetic track surface.

12. The test bench according to claim 11, wherein
the adjustment of the distance between the support platform and the magnetic track surface comprises:
raising the support platform in order to levitate the support platform from the magnetic track surface, and/or
lowering the support platform in order to lower the support platform from the levitated state onto the magnetic track surface.

13. The test bench according to claim 12, wherein
the adjustment of the position of the levitated support platform comprises:
translationally and/or rotationally moving the support platform.

14. The test bench according to claim 12, further comprising:
an air nozzle arrangement arranged and configured to generate an air cushion between the levitated support platform and the magnetic track surface.

15. The test bench according to claim 14, wherein
the control device is connected to the air nozzle arrangement and is configured to:
output an air nozzle arrangement control signal to the air nozzle arrangement, and
control the air cushion using the air nozzle arrangement control signal.

16. The test bench according to claim 11, further comprising:
a position sensor arrangement connected to the control device, the position sensor arrangement arranged and configured to:
detect a current position of the support platform as an actual position and to output the current position to the control device.

17. The test bench according to claim 16, wherein the control device is further configured to:
generate the magnetic track surface control signal based on a comparison of the actual position received from the position sensor arrangement and a target position received from an external control device.

18. The test bench according to claim 16, wherein the control device is further configured to:
generate an air nozzle arrangement control signal based on a comparison of the actual position received from the position sensor arrangement and a target position received from an external control device.

19. A method of controlling a test bench for safeguarding driver assistance functions of an automated motor vehicle, comprising:
outputting a magnetic track surface control signal to a magnetic track surface of a support platform of a test bench; and
adjusting:
a position of the support platform relative to the magnetic track surface, and/or
a distance between the support platform and the magnetic track surface, by changing magnetic forces generated by the magnetic track surface using the magnetic track surface control signal.

20. A control device for a test bench for safeguarding driver assistance functions of an automated motor vehicle, wherein the test bench comprises a support platform for a target, and a magnetic track surface for the support platform, wherein
the control device, which is connectable to the magnetic track surface, is configured to:
output a magnetic track surface control signal to the magnetic track surface and, using the magnetic track surface control signal, adjust:
a position of the support platform relative to the magnetic track surface, and/or
a distance between the support platform and the magnetic track surface by changing magnetic forces generated by the magnetic track surface.
